(19) United States
(12) Patent Application Publication
(10) Pub. No.: US 2010/0032372 A1
(43) Pub. Date: Feb. 11, 2010

(54) USE OF A PRIMARY LIQUID FILTRATION/STABILIZATION INSTALLATION FOR TRIPLE PURPOSE

(76) Inventors: Pierre Adam, Walhain (Tourinnes-Saint-Lambert) (BE); Winock Debyser, Grimbergen (BE); Benoit Formesyn, Brugge (BE); Patrick Haselaars, Koersel (BE)

Correspondence Address: Paul Grandinetti;Levy & Grandinetti, P O Box 18385, Washington, DC, 20036-8385, US

(21) Appl. No.: 12/448,047

(22) PCT Filed: Dec. 7, 2007
(86) PCT No.: PCT/EP2007/063557

§ 371 Date: Jun. 5, 2009

(30) Foreign Application Priority Data
Dec. 7, 2006 (EP) 06125625.1

(51) Int. Cl. B01D 37/02

(52) U.S. Cl. 210/635; 210/254; 210/806; 210/660

(57) ABSTRACT

The present invention relates to a primary liquid filtration/stabilization installation comprising in combination, a liquid in-feed line, a conventional dosing tank system for single use filter-aid and/or stabilization-aid, and an alternate dosing/storage tank system for regenerable filter-aid and/or stabilization-aid, wherein the installation is adapted to selectively operate one or the other of the dosing systems to meter doses of their respective charges into liquid that is delivered through the in-feed line, and a filter adapted to retain filter-aid material thereon, while passing liquid from which retained material has been removed.

### FIELD OF THE INVENTION

This invention provides an elegant solution wherein a primary liquid filtration/stabilization equipment can be variously—selectively used for filtration operations, regenerable PVPP stabilization operations or simultaneously for filtration and stabilization operations, when using synthetic filter-aid.

### BACKGROUND OF THE INVENTION

The significance of a filtration operation in industrial processing derives not only from its direct impact on the filtered material, but also because it can be one of the last opportunities that a producer has to directly impact one or more of the quality determinants of the product. In the case of brewing, for example, filtration is typically the final pre-packaging step in the brewing process, and therefore perhaps the last chance that a brewer has to directly effect (in both the pro-active and the remedial sense) a beer's initial quality and, from a constituents perspective, its shelf-life.

Filtration is generally understood in terms of a mechanical separation of various liquid/solid components from a suspended mixture thereof. These “suspensions”, (as used herein in the broad sense of the word, suspensions does not imply any particular particle size ranges, but only that the particulates are carried or suspended in the fluid flow), are passed through a porous filtration-aid and at least some of the particulates are retained on or within the filtration medium while the then at least partially clarified liquid, (i.e. the “filtrate”), exits the filtration unit.

While DE filtration, is and may remain a major if not dominant type of filter-aid mediated filtration (alluviation) for brewing and other industries, there are a number of emergent, alternative filtration technologies. Technologies such as cross-flow micro filtration and a variety of membrane techniques have been introduced. The most current developments are focused on the suppression of DE and/or perlite utilization, including the replacement of natural filter-aids by (esp. reusable) synthetic polymers. The synthetic filter-aids can be mixed with PVPP and the filter-aid or the mix of different filter-aids, including PVPP could be reusable after a regeneration process (see WO96/35497).

Haze is a visual manifestation of the physical instability of the beer, and can be subdivided into three main groups, biological, microbial and non-biological.

The precursors responsible for the non-biological instability are proteins and polyphenols, and more specifically tannins. The formation of their complexes is increasingly exacerbated by parameters such as concentration of precursors, heat, oxygen, heavy metals, aldehydes and movement.

The removal of polyphenols is possible by adsorption on polyvinylpolypyrrolidone (PVPP). Due to its chemical structure, PVPP reacts preferably with polymerised polyphenols through hydrogen bonds and electrostatic weak forces. The affinity of polyphenols towards PVPP is higher than towards haze-active proteins in beer, due to the fact that PVPP has more active sites than proteins. Moreover, the interaction between polyphenols and PVPP is stronger and faster than between polyphenols and proteins. A contact time of 5 minutes is generally recommended for the reaction to proceed to completion. PVPP exists in two forms, the single use and the regenerable form.
Single use PVPP is finer than the regenerable form and ranges between 9 and 50 μm, with an average size of 25 μm, and presents a high surface/weight ratio. It is generally dosed prior to the filtration, in combination with DE or in separate dosing vessel prior to DE addition at a typical dosage rate between 10 and 30 g/hl. The dosed PVPP is removed after reaction with polyphenols during the filtration step to make-up part of the filter cake.
Regenerable PVPP particle diameter ranges between 40 and 200 μm, with an average size of 110 and present a lower surface/weight ratio than single use PVPP. The dosage rate of regenerable PVPP is generally between 20 and 50 g/hl. In the case of regenerable PVPP systems, PVPP is dosed continuously into the bright beer stream and is collected on a specific and dedicated filter, where it can be regenerated by contact with a solution of sodium hydroxide (NaOH). The regeneration of PVPP, is an in situ process, and takes place at the end of the filtration and stabilization operations, whilst the PVPP is on the filter. The adsorbed polyphenols are re-dissolved in a hot solution containing between 1 and 2% of NaOH, and PVPP is afterwards neutralised with an acid solution to a pH of about 4.0. Therefore specific installation dedicated for the regeneration of PVPP is required. This process is the most economical way of producing a stable beer according to a shelf-life up to 6 months, for breweries having a filtration capacity higher than about 500,000 hl per year.
   Several filtration and stabilizing equipments exist, such as plate and frame filters, candle filters or horizontal leaf filters.

### SUMMARY OF THE INVENTION

Filtration operation and stabilization operation are different operations, and require specific installation in order to ensure that the process is realized under “best practice” conditions.

The filtration operation occurs before the filling operation, and provides some visual characteristics of the liquid to the consumers. The objective of the filtration operation is mainly the act of removing suspended particles from the liquid. These particulates include micro-organisms, such as yeast and bacteria, and at least haze pre-formed particles. This operation requires equipment, designed and dimensioned for that purpose.

The stabilization operation can and usually does occur at different moments of the process. This invention relates to the operation realized after or during, but not exclusively, the filtration operation. The objective of the stabilization operation is mainly the act of removing precursors to haze formation, such as polyphenols and/or haze sensitive proteins, which would otherwise react, by forming a haze in the packaged product. This operation requires, in function of the stabilization method, equipment designed and dimensioned for that purpose.

Currently, there is no flexibility in the commercially available equipments, and beer filters are only used for filtration and stabilization filters are only used for stabilization. Giving to the brewer the opportunity to selectively use an installation for a different application is considered as a great advantage. Such flexibility is particularly advantageous when the brewing market is subjected to seasonal variations.

It is an object of the invention to palliate at least some of these drawbacks by providing a filtration and/or stabilizing equipment that can be used as well for filtration operation as for stabilization operation or even both.

To this end, the filtration and/or stabilizing equipment according to the invention comprises
a first storage tank and a second storage tank,
a first filter element and a second filter element,
   said first storage tank being connected to the first filter element and said second storage tank being connected to the second filter element
a first nozzle interconnecting an outlet of said first filter element to an inlet of said second filter element, said first nozzle comprising a first valve assembly having an open position and a closed position,
   said open position being a position allowing the outlet of said first filter element to be connected to the inlet of the second filter element while the closed position isolates the outlet of said first filter element from the inlet of the second filter element, said first valve assembly comprising a first valve and a second valve, said first valve assembly being in open position when said second valve is open and said first valve is closed and being in closed position when said second valve is closed and said first valve is open.

According to this invention, the filtration and/or stabilizing equipment is adaptable to the process operation that is needed and the nature of the processing-aid, which is used for such operation. Typically the presented installation has been designed for a triple purpose:
classical DE filtration with or without stabilization, using single use products,
classical PVPP stabilization using regenerable products and
filtration using synthetic materials, mixed or not with PVPP for a complementary stabilization step.

Indeed, if the first valve assembly is in open position, the filtration is performed by sequentially using the first filter element and the second filter element that means that the filtrate which exits the first filter element enters the second filter element for further filtration.

An exemplary functioning is when the first storage tank comprises diatomaceous earth and the second storage tank comprises regenerable PVPP. This advantageous operating conditions further reduce the costs of the filtration step since using regenerable PVPP is less expensive than using single use PVPP.

If the first valve is in closed position, the filtration is performed in each filter element (first and second) independently one to each other and simultaneously. This means that the first filter element can for example use diatomaceous earth mixed with single use PVPP while the second filter element can use regenerable PVPP mixed with synthetic polymers, both first filter element being fed by the same unfiltered medium.

Similarly, the first filter element can be fed with unfiltered medium to which regenerable PVPP mixed with synthetic polymers is added from said first storage tank as first filter aid and the second filter element can be fed with unfiltered medium to which diatomaceous earth is added from said second storage tank as second filter aid.

In another variant both first and second storage tank can contain the same filter-aid being for example a mixture of diatomaceous earth with single use PVPP or a mixture of regenerable PVPP with synthetic polymers for example when a greater production is needed (in summer).

As it can therefore be concluded, the equipment is really very flexible and the switch from one operating condition to another is very easy to realize as it needs only to change the content of the storage tank.

Particularly, the filtration and/or stabilizing equipment according to the invention further comprises a second nozzle connecting an inlet of said first filter element to an outlet of a third storage tank provided to contain unfiltered medium, said second nozzle being further connected to said first valve for connecting said third storage tank to said inlet of said second filter element when the first valve assembly is in closed position.

It can be useful to dispose of a buffertank of unfiltered medium to avoid flow rate turbulences etc.

Advantageously in the filtration and/or stabilizing equipment according to the invention, said first nozzle comprises a second valve assembly between said second filter element and said second storage tank, said second valve assembly having an open position and a closed position, said open position being a position where the second filter element is connected to the second storage tank and the closed position is a position where the second filter element is isolated from said second storage tank.

Preferably, the equipment according to the invention further comprises a fourth storage tank, having an outlet connected to said first nozzle by means of at least one third valve which is in closed position when the second valve assembly is in opened position and which is in open position when the second valve assembly is in closed position thereby allowing the connection between the fourth storage tank and the second filter element.

This advantageous feature increases the flexibility of the equipment. Indeed instead of emptying the second storage tank if its filter-aid content to fill it with another one, it is possible to switch the second valve for feeding from a fourth storage tank another filter aid than the one that is contained in the second storage tank.

For example, in the summer, it can be appropriate to change the operating conditions both first and second storage tank should preferably comprise a mixture of diatomaceous earth and single use PVPP, as filter aid and the first and second filtration units are in operation independently one from each other and simultaneously to increase the production yield. But in the winter, it can be needed to re-use a conventional filtration combination being a sequential filtration comprising a first filtration with diatomaceous earth followed by a second filtration with regenerable PVPP that is less expensive than the aforesaid filtration used in the summer. However, this filtration that is less rapid is more adapted to a lower production (in winter).

Preferably, the first, the second or the fourth storage tank provided to contain a filter aid medium chosen in the group consisting of Kieselguhr medium, diatomaceous earth, perlite, single use PVPP (polyvinylpolypyrrolidone), regenerable PVPP, silicagels, bentonite (earth), synthetic materials, and their mixture.

Particularly, the synthetic material is chosen in the group consisting of polyamide, polyvinylchloride, fluocinated products, poly-propylene, polystyrene, polyethylene, polybutene, polymethylpentene, ethylene copolymers, binary copolymers and terpolymers with acrylics, olefinic thermoplastic elastomer, PVPP or a mixture thereof, polypolymers and co-extrusion thereof, and their mixture.

In a preferred embodiment, the synthetic material has an average diameter ranging between 25 and 50 μm and preferably between 30 and 40 μm.

In still a preferred embodiment, the first filter element is an horizontal leaf filter, a candle filter or a vertical leaf filter and wherein the second filter element is a candle filter.

Advantageously, said medium is a fruit or grain based beverage, particularly a cereal based beverage, more particularly a malt based beverage and most particularly a fermented beverage, preferably beer.

Particularly, the medium presents a pH between 2 and 6 and preferably between 3 and 5. In a particularly embodiment, said first storage tank and said second storage tank both comprising a mixture of Kieselguhr or diatomaceous earth or perlite with single use PVPP, being a condition particularly adapted for summer production being more important than winter production.

In another particular embodiment, more adapted for winter production, said first storage tank and said second storage tank comprising Kieselguhr, diatomaceous earth or perlite, said fourth storage tank comprises regenerable PVPP.

In a variant, said fourth storage tank comprises a mixture of regenerable PVPP with synthetic polymers. This operation condition is particularly advantageous and allows a one step filtration such as with diatomaceous earth with single use PVPP but less expensive since synthetic polymers and PVPP mixture is regenerable. It is of cause comprised in the scope of this application that both first and second filter element operates with this mixture as filter aid.

Other embodiments of the equipment according to the invention are mentioned in the annexed claims.

The invention relates also to a filtration and/or stabilizing method of an unfiltered medium comprising:
a first addition of a first filter aid from a first storage tank to said unfiltered medium coming from a third storage tank,
a first filtration of said unfiltered medium comprising said first filter aid to obtain a first filtrate,
a second addition of a second filter aid from a second or a fourth storage tank to a second unfiltered medium,
a second filtration of said unfiltered medium comprising said second filter aid to obtain a second filtrate,
a switch of a first valve assembly from a closed position to an open position, said closed position being a position where the first filtration is followed by the second filtration, said first filtrate being said second unfiltered medium subjected to the second filtration and the open position being a position where the first filtration is performed independently and simultaneously with respect to the second, said unfiltered medium being the same as the second unfiltered medium, said first filter aid and said second filter aid being the same or not.

Particularly, the method further comprises a switch of a second valve assembly from a closed position to an open position to add the second filter aid from said second storage tank or from an open position to a closed position together with a switch of a third valve from a closed position to an open position to add the second filter aid from said fourth storage tank.

In this method classical DE filtration operation is selected for the second filter element when unfiltered liquid is supplied to the second filter element by the liquid in-feed line, and when the alternate dosing/storage tank (fourth storage tank) is isolated from the installation and therefore when the second valve assembly or set of valves are in opened position.

Classical PVPP stabilization is selected when filtered liquid is supplied to the second filter element by the liquid in-feed line, and when the conventional dosing tank is isolated from the installation and therefore when at least the second valve assembly or set of valves are closed and when the first valve assembly is closed to allow communications between first and second filter element.

Filtration and optionally stabilization using synthetic materials is selected when unfiltered liquid is supplied to the second filter element by the liquid in-feed line, and when the dosing tank is isolated from the installation and therefore when at least the second valve assembly or set of valves are closed and when the first valve assembly is open to isolate said first filter from said second.

Other embodiments of the method according to the invention are mentioned in the annexed claims.

Other characteristics and advantages of the invention will appear more clearly in the light of the following description of a particular non-limiting embodiment of the invention, while referring to the figures.

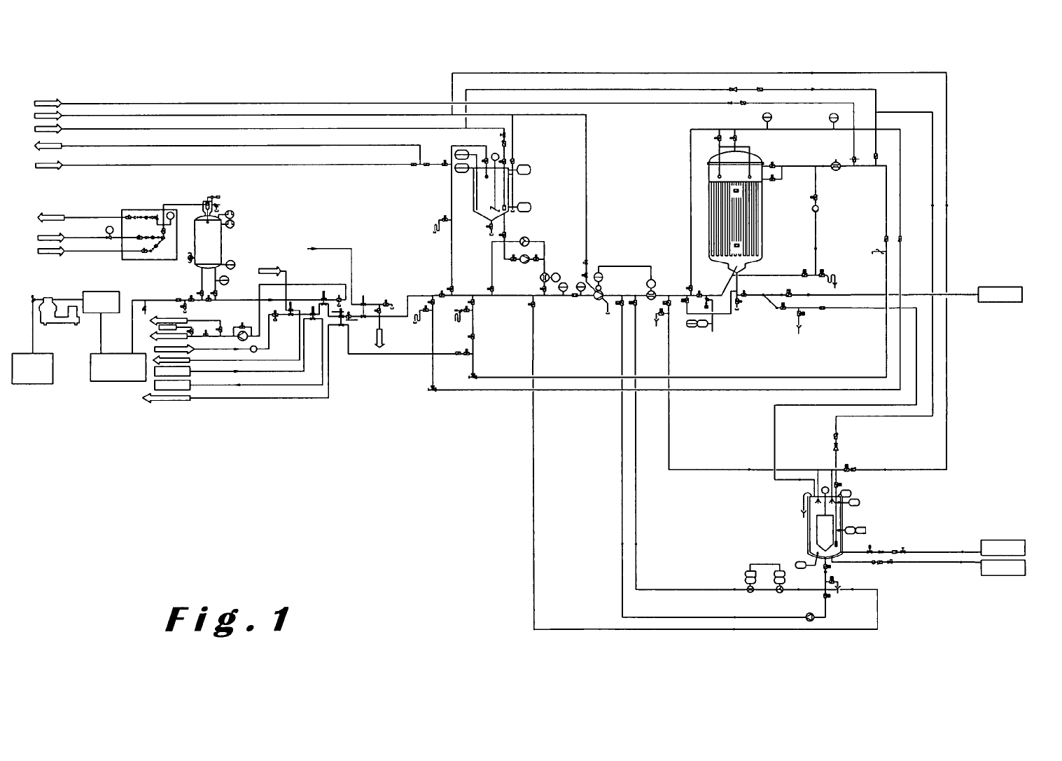

FIG. 1 is a graphical representation of the flow-sheet of the filtration/stabilization installation and the different elements of it.

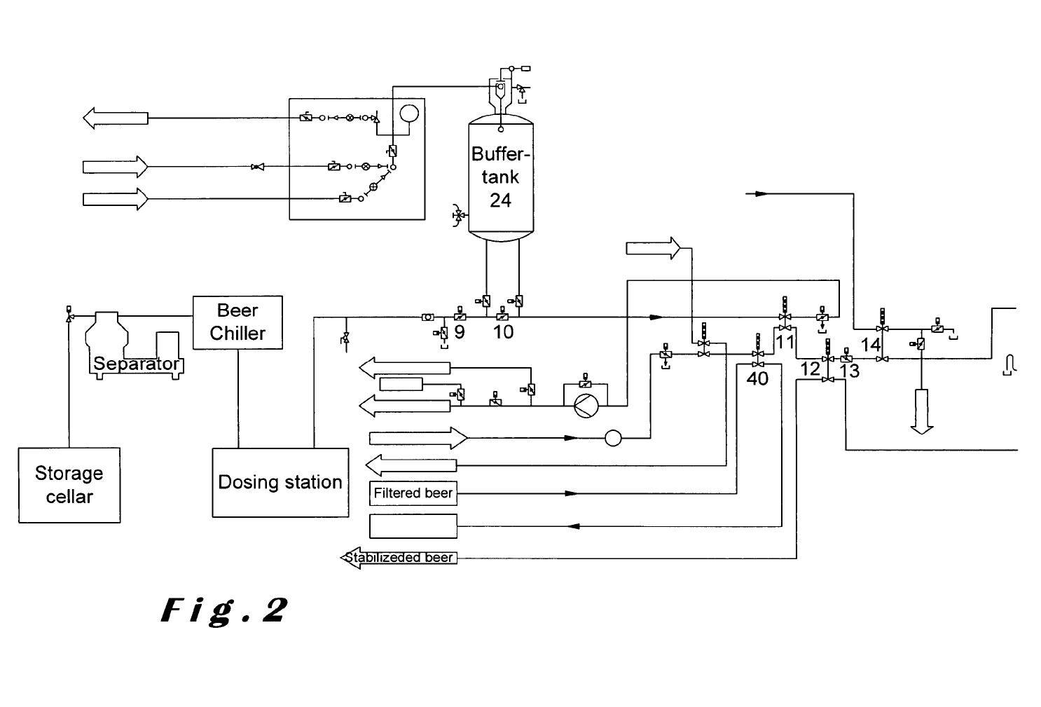

FIG. 2 is a graphical representation of the inlet and outlet connections means of the liquid in the liquid in-feed line of the installation presented in FIG. 1.

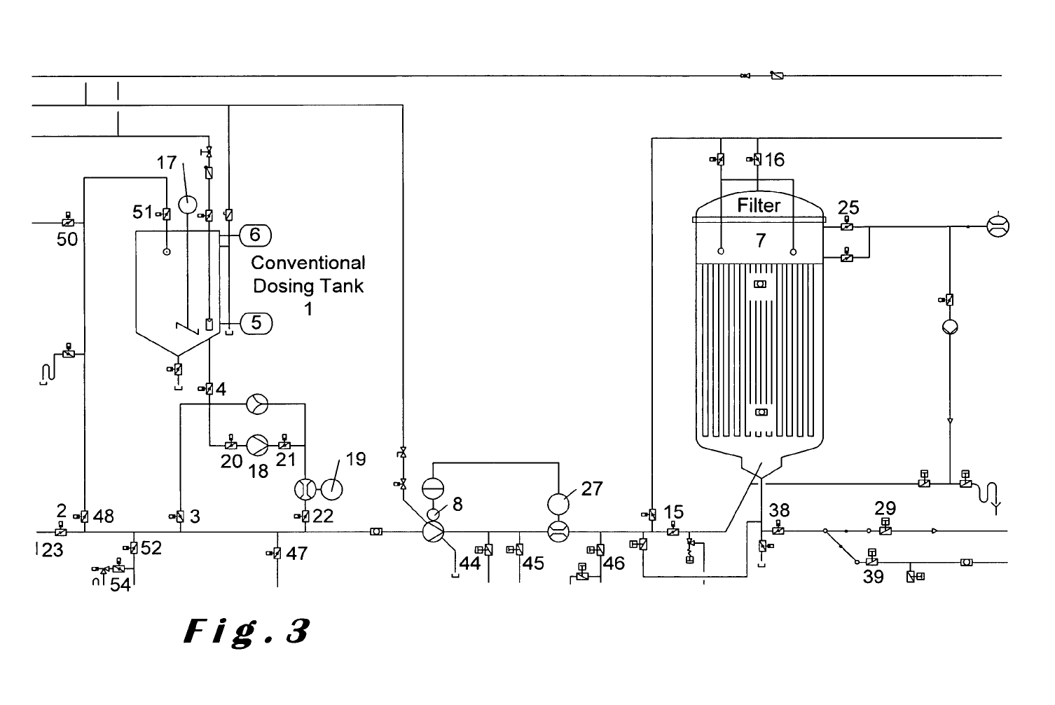

FIG. 3 is a graphical representation of the conventional dosing tank, the filter and the liquid in-feed line.

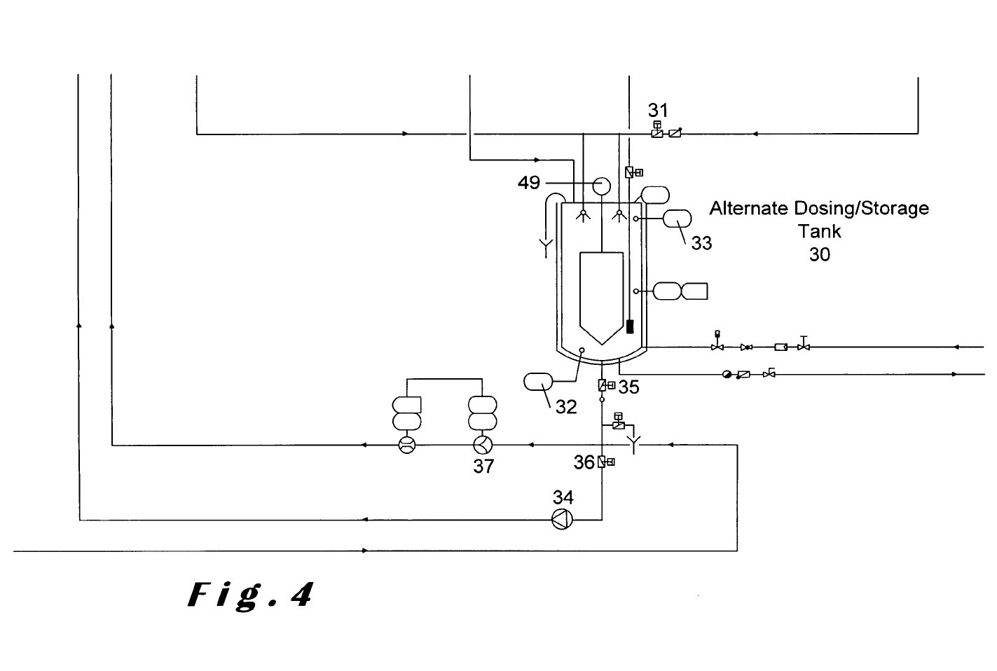

FIG. 4 is a graphical representation of the alternate dosing/storage tank.

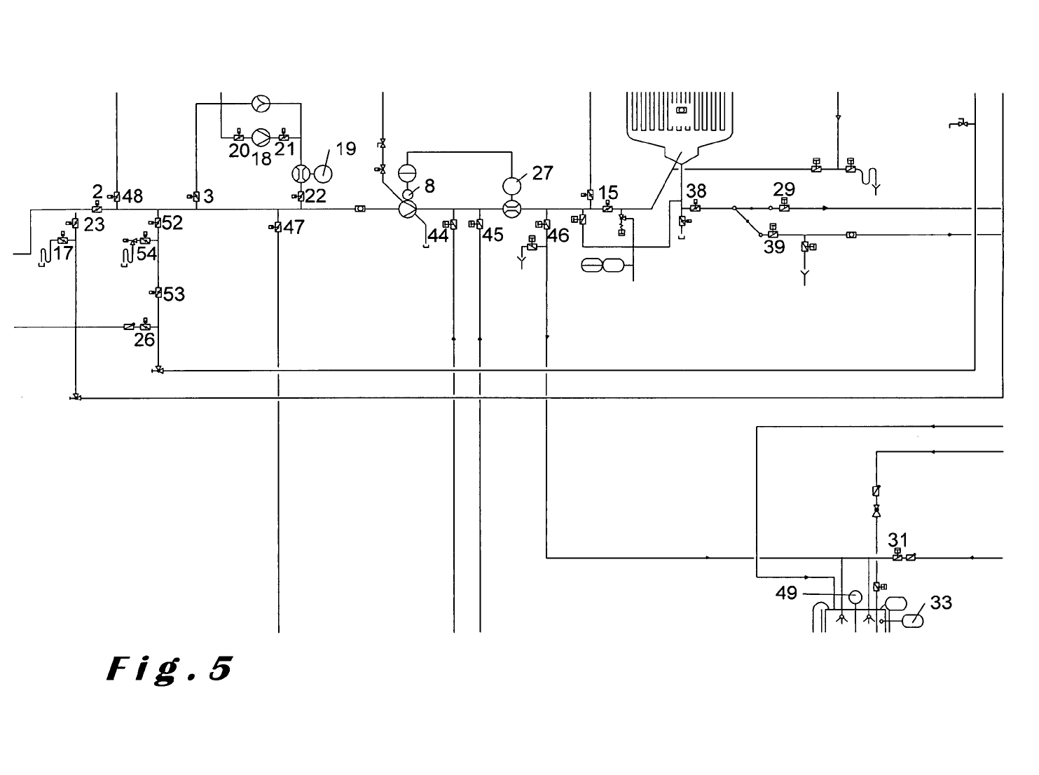

FIG. 5 is a graphical representation of connections means between the alternate dosing/storage tank, the filter and the liquid in-feed line of the installation presented in FIG. 1.

In the drawings, a same reference sign has been allotted to a same or analogous element of the equipment according to the invention.

### DETAILED DESCRIPTION OF THE INVENTION INTRODUCTION

Typical equipment of a beer filter line, generally include centrifuge, chiller, buffer tank, pumps, flow meters, pipes, valves, beer filter and optionally stabilization equipment, which are connected together, and which are dimensioned for the capacity of the beer filter. The capacity of the filter is a function of the specific filtration surface, and is expressed in hectolitre per hour (hl/h), such as that the entire line has the same capacity.

This invention relates to the utilization of equipment, which can be used as well for filtration operation as for stabilization operation. The closed filter equipment, which included candle filter, horizontal and vertical leaf filter, presents the advantages of being totally automated, and being compatible with a regeneration process, which could be operated into the filter (in situ process). This application will therefore concern this type of powder closed filter equipment.

The present invention relates to a primary liquid filtration/stabilization equipment comprising in combination, a liquid in-feed line, a conventional dosing tank system (first storage tank) for single use filter-aid and/or stabilization-aid, and an alternate dosing second storage tank system for regenerable filter-aid and/or stabilization-aid, wherein the installation is adapted to selectively operate one or the other of the dosing systems to meter doses of their respective charges into liquid that is delivered through the in-feed line, and a filter adapted to retain filter-aid material thereon, while passing liquid from which retained material has been removed (FIG. 1).

According to this invention, the equipment of the filtration and stabilizing installation can be selected in function of the process operation and the nature of the processing-aid, which is used for such operation. An example of this kind of installation is presented in FIG. 1. Typically the presented installation has been designed for a triple purpose:
classical DE filtration with or without stabilization, using single use products,
classical PVPP stabilization using regenerable product and
Filtration using synthetic materials, mixed or not with PVPP for a complementary stabilization step.

The selection of the different elements of the installation in function of the operation is selectively done by choosing the appropriate program:
Classical DE filtration operation is selected when unfiltered liquid is supplied to the filter (7) by the liquid in-feed line, and when the alternate dosing/storage tank (30) is isolated from the installation and therefore when at least the valves (47), (42), (43) and (46) are closed (FIG. 3).
Classical PVPP stabilization is selected when filtered liquid is supplied to the filter (7) by the liquid in-feed line, and when the conventional dosing tank (1) is isolated from the installation and therefore when at least the valves (48), (3) and (22) are closed (FIGS. 4&5).
Filtration and optionally stabilization using synthetic materials is selected when unfiltered liquid is supplied to the filter (7) by the liquid in-feed line, and when the dosing tank (1) is isolated from the installation and therefore when at least the valves (48), (3) and (22) are closed (FIGS. 4&5).

According to this invention, the liquid that is passing through the installation can be a fruit or a cereal based beverage, characterized by a pH of between 4 and 6, wherein the cereal based beverage is a malt based beverage, which can be fermented, and therefore characterized by a pH of between 3 and 5, including beer.

The application of the present invention and the particulars of its disclosure herein are primarily focused on filtration using Kieselguhr, diatomaceous earth (DE), and/or perlite, commonly called DE powder filtration. In DE powder filtration (alluviation), the DE filter-aid is injected into the beer stream at a location slightly upstream of the point where it is collected on a supporting mesh. Beer filtration is started when the pre-coats are established and the recirculating liquid is clear. The beer stream bearing the DE, together with the yeast and other suspended solids, then forms a largely “incompressible” mass referred to as the “filter-cake.” To prevent clogging of small pores of the filter and to achieve extended filter runs; the filter-aid is continually metered into the unfiltered beer as “body-feed.”

For alluviation filtration processes in general, (and including in particular those in which Kieselguhr, and the like is employed as the filter-aid), the common industrial filters can be classified by the following typology: 1) frame filters; 2) horizontal filters; and 3) candle filters.

Note in this connection that frame filters are what is referred to as “open”, and are not fully automated systems. Horizontal and candle filters, by comparison are “closed” and fully automated systems.

In practice, a filtration system using filter-aid in alluviation typically comprises of the followings:
A mechanical support.
An initial layer of coarse filter-aid known as the first “pre-coat”, which acts as an intermediate layer bridging the gaps in the mechanical support and acting as a support for the subsequent finer pre-coats or body-feed.
A second pre-coat layer composed of a finer grade of filter-aid than used for the first pre-coat.
A progressively accumulating filter-cake composed of a matrix of body-feed, yeast, protein, carbohydrate particles, haze particles and other colloidal materials.

Entrapment, absorption and surface filtration are the major mechanisms by which filter-aid filtration functions. According to this model the beer particles are captured within the pores created between the particles of filter-aids and are removed according to their size and the dimensions of the pores in the filtration surface. The flow rate of beer through the filter is generally about 4-5 hl/h.m² and has an influence on the filtration efficiency, as a slower rate ensures more efficient particle retention. The flow rate can be much higher, in the range of 8 to 11 hl/h.m² if a high permeability cake can be maintained.

The length of filter run is determined when the useful volume of the filter is totally occupied by the cake volume, or when the pressure increase, associated to the increase of the bed volume and the decrease of the permeability of the resulting cake has reach the upper limit guaranteed by the equipment supplier.

This invention relates to the utilization of equipment, which can be used as well for filtration operation as for stabilization operation or both.

According to the invention, the first and the second filter element are chosen in the group consisting of a candle filter, an horizontal leaf filter or a vertical leaf filter. The first filter element is preferably an horizontal filter while the second is preferably a candle filter.

A typical candle filter (CF) consists of a cylindroconical tank, which is separated in filtrate and retentate area by a plate, or equivalent. Another plate above this separation plate is used for filtrate collection. The cylindrical part of the tank encloses the retentate area, while the conical part ensures a proper distribution of the raw filter-aid (DE) and collects and discharges the waste filter-aid at the end of the procedure. The unfiltered beer enters the tank from the bottom tip of the conical part. The cylindrical candles are mounted vertically to the middle plate. They occupy around 55-75% of the tank volume. A modern candle comprises a trapezoidal spiral wire welded, eight times per revolution, to rectangular support bars. The candle opening is asymmetric in that, externally it is 70 μm while internally; it is somewhat larger, thus avoiding the risk of plugging.

A flow rate of about 3.5 to 6.0 hl/h.m² is generally adopted during the filtration step. The candle filter construction is often designed for an operation pressure of max. 7 bar.

A horizontal filter (HF) consists of a one-piece tank with two fixed horizontal metal plates. The element package consists of plate-like filter elements which are fixed to the central hollow shaft and are able to rotate due to a drive assembly. A leaf usually consists of a carrier plate supporting a strong coarse mash which, in turn, supports a fine mesh of openings of, for example only), about 70 μm. The operation advantage of this type of filter is that it provides a stable cake. A flow rate of about 5.0 to 8.0 hl/h.m² is generally adopted during the filtration step.

Unfiltered beer can enter the horizontal filter in two different ways depending on whether the particular horizontal filter is of the older S type or the more recent Z type.

### Processes Using Diatomaceous Earth.

The most commonly used filter-aid is constituted of diatomaceous earth (DE), which is a form of amorphous silica, or perlite, which is obtained from volcanic stones. There exists different sizes of natural filter-aids and the brewers define some specifications and use DE and/or perlite in specific mixtures, in order to achieve beer's specifications. Two or three different grades are generally used to ensure maximum filtration efficiency, depending on the beer type being filtered. Furthermore, the quality of the filtered beer may vary, for example change to yeast concentration and seasonal variations of ingredients, particularly the malt. Therefore, judicious mixing of two grades to make up a body-feed is often practised. The quantity of solid material in the unfiltered beer is influenced by the maturation process to settle yeast and by the equipment to remove yeast, such as the presence of a centrifuge upstream filtration operation. Processing-aids, such as finings and proteolytic enzymes, can impact on the amount of body-feed required. Typical amounts range between 40 and 200 g/hl.

In practice, when the second filter element is selected for a classical DE filtration (FIGS. 2&3), both first and second filter elements are operating each independently one to each other and simultaneously. In this case, the first valve assembly is in closed position and both filter elements are isolated one to each other. Valve 40 is closed while vale 11 is open. The filter aid from the first storage tank or from the second storage tank can be the same or different. However, the first is functioning as a conventional filter element and will not be described herein in details. DE is prepared and is dosed via the conventional dosing tank (1). During the preparation of DE suspension, the tank is filled, with deaerated water (DW). During that phase, valves (50), (51), are opened to allow the supply of DW. The tank is equipped with, at least, two sensors, one is to detect the low level (5) of the DE suspension in the tank and therefore commands the supply of fresh DW, and the other one is to detect the high level (6) in the tank and therefore stops the supply of fresh DW. DE powder is added (usually manually) by operator into the tank, which is equipped with an appropriate propeller (17), in order to ensure a correct homogeneity in the prepared DE suspension presents in the tank.

The filtration process starts with a “conditioning” phase, which means that the filter itself and the different pipes, used during the filtration step, are under water. This step is mainly done to avoid direct contact between oxygen and beer, and it is recommended as best practice to use DW for that purpose. The filter (7) is filled from the bottom with DW, which is pumped (8) by the liquid in-feed line, when valves (9), (10), (11), (13), (2), (15) are opened and when (12), (14) are closed. To avoid excessive consumption of DW, the filter will be put in recirculation, by using the by-pass loop, when valves (52), (53), (54) and (25) are opened.

When the filter and the lines are enough deaerated, the filtration operation can start with the deposition of pre-coats on the filtration medium. Two pre-coats using different particle sizes are generally used, the first being constituted by bigger particles and the second one, using finer particles. The first pre-coat is used to cover the filtration media of the filter and the second one is retained by the first one. A quantity between about 1 and 2 kg/m2 is frequently used, as the distribution size used for pre-coating is bigger than for body-feeding. The flow of DW is about 1.5 more than the filtration flow, in order to be sure that the entire surface of the filter medium is covered by enough filter-aid, in order to guarantee the quality of the first volume of filtered beer. When adding the pre-coat to the filter, DE suspension is pumped via (18) at a determined flow rate, which is controlled by a flow meter (19), when at least valves (4), (20), (21) and (22), are opened, forming the so-called second valve assembly in the opened position. To avoid excessive consumption of DW during the pre-coat deposition, the filter is placed in recirculation by using the by-pass loop, when valves (52), (53), (54) and (25) are opened.

Unfiltered beer is chilled, and can be supplied to the filter using the same way, by passing through a buffer tank (24), (third storage tank), which is positioned between the centrifuge (separator) and the filter, this step is frequently called “prerun” or “vorlauf”. When the specific gravity of the blending between beer and water becomes higher than a predetermined target, the filtered liquid is recovered into the pre and post run filtered liquid tank, by using the following opened valves (25), (26), when (12) is closed, this step could be considered as the starting point of the production. The flow of unfiltered beer during the injection of DE, is done by the pump (8), which is controlled by the flow meter (27). The flow rate during the injection is adjusted to maintain enough body-feed in order to obtain the expected filtration results. A DE quantity of about 100 g/hl of beer is generally recommended for centrifuged beer, using the separator equipment and having a yeast population lower than 200,000 cell/ml, as it is the case in the example presented in this invention.

At the end of the production step, when the amount of processing-aid dosed and deposit on the filter has reach the limit space between filtration medium, or when the differential pressure has reach the maximum limit allowed by the filter supplier, water is supply to the filter line. This operation is called “postrun” or “nachlauf”, and is the reverse operation than the previous one, called “vorlauf”, using exactly the same pipes and valves. As it was explained before, the mixture beer/water is recovered to the pre and post run filtered liquid tank when the specific gravity of the diluted beer is higher than a predetermined target. After that moment, the blending is not recovered and is put to the drain, which determines the end of the production phase.

The filter-cake should be removed from the filter medium, by using DW and CO2 and should be pumped to the drain, when valves (38) and (29) are opened. The installation should be cleaned before starting a new filtration process.

In some cases, it can be needed to use the equipment according to the invention with a synthetic polymers as filter aids in function of the required quality of the beer to obtain or in function of the production capability required. The synthetic filter-aids can be mixed with PVPP and the filter-aid or the mix of different filter-aids, including PVPP could be reusable after a regeneration process.

This invention includes the utilisation of synthetic filter-aid, derivatives of silica, including ryolites of glass, and mixture thereof, as processing-aid used for the filtration of a liquid. Synthetic polymers are based variously on any one or more of, polyamide, polyvinylchloride, fluorinated products, polypropylene, polystyrene, polyethylene, polybutene, polymethylpentene, ethylene copolymers, binary copolymers and terpolymers with acrylics, olefinic thermoplastic elastomers. Practically, the filtration results are very closed to DE filtration results, by using regenerable synthetic filter-aid particles having an average diameter ranging between 25 and 50 μm and preferably between 30 and 40 μm.

The filter-aids can be mixed with PVPP, and therefore can be used, for filtration process or for simultaneously filtration and stabilization processes, what we call hereafter a combine process. For the combine process, the mixture of PVPP and filter-aid are used as well for the pre-coat, as for the body-feed deposition on the filter support, resulting in an improvement of the colloidal stability, due to the specific interaction between polyphenols and PVPP.

In practice, the filtration or the combine process uses the same grade of processing-aid for the pre-coat and for the body-feed deposition. The processes occur on a similar way, and as the classical filtration process does, in such a way that it comprises of the followings:
A mechanical support, candle or leaf.
A pre-coat layer composed of processing-aid, which acts as an intermediate layer bridging the gaps in the mechanical support and acting as a support for the subsequent pre-coats or body-feed.
A progressively accumulating filter-cake composed of a matrix of body-feed, yeast, protein, carbohydrate, polyphenols, haze particles and other colloidal materials.

Using synthetic processing-aids, one pre-coat is enough, wherein it acts as a support for the body-feed that will build up during the entire process operation. The pre-coat uses the same grade as it is used for the body-feed. Generally the concentration of the processing-aid suspension is between 5 and 15% of the dry matter. A higher concentration is susceptible to create problem by blocking the dosing pump, an on the other hand a lower concentration will cause an unnecessary dilution of the beer during the body-feed dosage. The flow of water during the pre-coat operation should be at least 1.5 times the normal flow used during the body-feed operation. This operation is important to obtain a regular deposition of the pre-coat, on the total filtration surface, and therefore to reach the required specifications of the filtered product for the first volume passing through the filter. Generally the deposit quantity is about 2 and 4 mm on the filtration area of the filter, which correspond to approximately a quantity per surface filtration unit of about 2 to 4 kg/m². The body-feed dosage rate of regenerable processing-aid is generally between 60 and 200 g/hl, is dosed continuously into the bright beer stream and is collected on a specific and dedicated filter. The most common filters are candle filter, horizontal leaf filter or vertical leaf filter, which are closed equipment, in order to allow the in situ regeneration process. When the mixture contains PVPP, a contact time of about 5 minutes is considered as good practices, and is provided by the supply beer pipe and the average residence time within the filter. The optimum recommended flow rate on the filter is about 5-10 hl/h.m² which is approximately the double of the typical flow rate of the beer on the filter using DE as filter-aid.

The filter-aid or the mixture of different filter-aids, including PVPP, are reusable after a regeneration process, and which include the following steps:
Washing the filter medium with a soda solution at a concentration varying between 2% and approximately 5% and at a temperature of at least approximately 80° C. for between 60 minutes and approximately 120 minutes, and
Treating the filter medium with an enzyme composition at a temperature varying between approximately 40° C. and 60° C. for between approximately 100 minutes and approximately 200 minutes, said enzyme treatment being carried out after a plurality of filter cycles.

Similar closed equipment as used for the DE filtration operation are used such as candle filter and vertical or horizontal leaf filters, which allow the in situ regeneration process and which are fully automated.

When the second filter element is selected to process beer using synthetic polymers as processing-aid, which can be either or both filter-aid or stabilization-aid (FIGS. 2, 3, 4, & 5), processing-aid is prepared and dosed via a alternate dosing/storage tank (fourth storage tank) (30). During the preparation of processing-aid suspension, the tank is filled, with process water (PW). During that phase, at least valve (31) is opened to allow the supply of PW. The dosing/storage tank is equipped, at least, with two sensors, one is to detect the low level (32) of the processing-aid suspension in the tank and therefore commands the supply of fresh PW, and the other one is to detect the high level (33) in the tank and therefore stops the supply of fresh PW. Synthetic polymers are manually added by operator to the tank, which is equipped with an appropriated propeller (49), in order to ensure a correct homogeneity in the prepared processing-aid suspension presents in the dosing/storage tank. The concentration of the processing-aid suspension is generally about 10%, and the suspension is sterilized before the first utilization, by using a hot caustic solution (for example 2% of NaOH at 80° C.) followed by a washing with PW.

The filtration process starts with a conditioning phase, which means that the filter itself and the different pipes, used during the filtration step, are under water. This step is mainly done to avoid direct contact between oxygen and beer, and it is recommended as best practice to use DW for that purpose. The filter (7) is filled from the bottom with DW, which is pumped (8) by the liquid in-feed line, when valves (9), (10), (11), (13), (2), (15) are opened and when (12), (14) are closed. To avoid excessive consumption of DW, the filter will be put in recirculation, by using the by-pass loop, when valves (52), (53), (54) and (25) are opened.

When the filter and the lines are enough deaerated, the filtration operation can start with the deposition of the pre-coat on the filtration medium. A quantity between about 2 and 4 kg/m2 is frequent when synthetic polymers are used, as the same material with the same distribution size is used for pre-coating and for body-feeding. The flow of DW is about 1.5 more than the filtration flow, in order to be sure that the entire surface of the filter medium is covered by enough filter-aid, in order to guarantee the quality of the first volume of filtered beer. Dosage of the pre-coat is realized from the fourth dosing/storage tank, which contain the total amount of processing-aid necessary for the ongoing process, and should be as short as possible by using specific pump (34), when the valves (35), (36) and (44) are opened. To avoid excessive consumption of DW during the pre-coat deposition, the filter is placed in recirculation by using the by-pass loop, when valves (52), (53) (54) and (25) are opened. Unfiltered beer is chilled, and can be supplied to the filter using the same way, by passing through a buffer tank (24), which is positioned between the centrifuge (separator) and the filter, this step is frequently called “prerun” or “vorlauf”.

The dosing of processing-aid is simultaneously realized from the alternate dosing/storage tank (30), by using the specific dosage pump (37) when the valve (35) and (45) are opened. When the specific gravity of the blending between beer and water becomes higher than a predetermined target, the filtered liquid is recovered into the pre and post run filtered liquid tank, by using the following opened valves (25), (26), when (12) is closed, this step could be considered as the starting point of the production.

At the end of the production step, when the total amount of processing-aid is dosed and deposit on the filter, or when the differential pressure has reach the maximum limit allowed by the filter supplier, water is supplied to the filter line. This operation is called “postrun” or “nachlauf”, and is the reverse operation than the previous one, called “vorlauf”, using exactly the same pipes and valves. As it was explained before, the mixture beer/water is recovered to the pre and post run filtered liquid tank when the specific gravity of the diluted beer is higher than a predetermined target.

After that moment, the blending is not recovered and is put to the drain, which determines the end of the production phase and the start of the regeneration process. The possible residual quantity of processing-aid can be pumped to the filter by using pumps (34) and/or (35) used for the pre-coat deposition, before starting the regeneration or after the first caustic treatment. In the present invention the regeneration process will be realized within the filter, referring to in-situ process and will use the different chemical solutions available for the cleaning and disinfection operations of the installation, what the brewer called “Cleaning in Place” (CIP). The temperature of the filter is progressively increased by adding hot water at a temperature around 80° C., which is the appropriate temperature required for the caustic treatment. The concentration of caustic soda is generally around 2% and is necessary to dissolve the polyphenols fixed on the surface of the PVPP and to release the yeast cell wall and the trub captured within the filter-cake. This first “attack” occurs during a period between 30 and 60 minutes, depending on the quantity of soluble material and the concentration of the caustic solution. The filter-cake is afterwards successively washed with hot water at 80° C., cold water at room temperature (PW) and iced and deaerated water (DW). Before starting a new filtration process the cleaned filter-cake should be removed from the filter medium, by using DW and CO2 and should be pumped to the alternate dosing/storage tank (30), when valves (38) and (39) are opened. The processing-aid is now ready to start a new filtration process. The processing-aid can be used several times without the need of a total regeneration process, which include enzymes capable of lysing the yeast cell.

When the brewer observes a reduction of the filtered volume during filtration run, due to an excessive increase of the differential pressure, it is highly recommended to start the enzymatic regeneration process as it is described in the patent WO96/35497, which occurs also in situ when the total amount of processing-aid is located in the filter on the filtration medium. The full regeneration process includes three different steps; the first step is a caustic dissolution of organic material, the second one is the action of specific enzyme(s), and third one is a final caustic treatment. In order to precede the entire regeneration of the filter-cake, the previous regeneration with caustic soda solution is followed by the addition of enzyme with specific activities, which include at least enzyme capable of lysing yeast cell wall. It is not mandatory, but the results are better when the pH and the temperature of the solution are maintain and stabilized at respective values around 5 for the pH and 50° C. for the temperature. The temperature of 50° C. can be obtained by using an external heat exchanger. The addition of the enzyme(s) is realized by an appropriate tank and the contact time of the enzyme with the filter-cake depends on the enzyme requirement, and is generally between around 30 and 90 minutes. The enzymatic action is followed by a similar process, which includes regeneration with caustic soda solution. For that purpose, the concentration of the caustic soda solution can be reduced to 0.5%, due to the first two steps of the entire regeneration process.

When the filter-cake is totally regenerated, the processing-aid is free of organic material and can be reused for other filtration runs. Before starting a new filtration process the cleaned filter-cake should be removed from the filter medium, by using DW and should be pumped to the alternate dosing/storage tank (30), when valves (38) and (39) are opened.

In other applications, the equipment has to be used as a stabilizing equipment in combination with a filtration equipment.

When the second filter element is selected to treat filtered beer using a classical PVPP stabilization (FIGS. 2, 3, 4 & 5), PVPP is prepared and dosed via the fourth storage tank (30). During the preparation of PVPP suspension, the tank is filled, with process water (PW). During that phase, at least valve (31) is opened to allow the supply of PW. The dosing/storage tank is equipped, at least, with two sensors, one is to detect the low level (32) of the PVPP suspension in the tank and therefore commands the supply of fresh PW, and the other one is to detect the high level (33) in the tank and therefore stops the supply of fresh PW. PVPP is manually added by operator to the tank, which is equipped with an appropriated propeller (49), in order to ensure a correct homogeneity in the prepared PVPP suspension presents in the dosing/storage tank. The concentration of the PVPP suspension is generally about 5-10%, and the suspension is sterilized before the first utilization at 80° C., by using double heating jackets, which has also the advantage to remove the undesirable dissolved oxygen of the PVPP suspension.

The stabilization process starts with a conditioning phase, which means that the filter itself and the different pipes, used during the stabilization step, are under water. This step is mainly done to avoid direct contact between oxygen and filtered beer, and it is recommended as best practice to use DW for that purpose. The filter (7) is filled from the bottom with DW, which is pumped (34) by the liquid in-feed line, when valves (9), (10), (11), (13), (2), (15) are opened and when (12), (14) are closed. To avoid excessive consumption of DW, the filter will be put in recirculation, by using the by-pass loop, when valves (52), (53), (54) and (25) are opened.

When the filter and the lines are enough deaerated, the stabilization operation can start with the deposition of the pre-coat on the filtration medium. A quantity between about 0.5 kg/m2 is frequent when PVPP are used. The flow of DW is about 1.5 more than the stabilization flow, in order to be sure that the entire surface of the filter medium is covered by enough PVPP, in order to guarantee the quality of the first volume of stabilized beer. Dosage of the pre-coat is realized from the alternate dosing/storage tank, which contain the total amount of PVPP necessary for the ongoing process, and should be as short as possible by using specific pump (34), when the valves (35), (36) and (44) are opened. To avoid excessive consumption of DW during the pre-coat deposition, the filter is placed in recirculation by using the by-pass loop, when valves (52), (53), (54) and (25) are opened. Filtered beer, coming from a separate filter or separate tanks of filtered beer, is supplied to the beer line by using the valves (40), (2) and (15), which are opened when (12) and (14) are closed. This step is frequently called “prerun” or “vorlauf”.

The dosing of PVPP is simultaneously realized from the fourth storage tank (30), by using the specific dosage pump (37) when the valve (35) and (45) are opened (at least third valve). When the specific gravity of the blending between beer and water becomes higher than a predetermined target, the filtered liquid is recovered into the pre and post run filtered liquid tank, by using the following opened valves (38), (26), when (12) is closed, this step could be considered as the starting point of the production. During the stabilization process, the flow rate of the beer on the filter is adapted to the equipment. The same pump (8) is used and controlled by the same flow meter (27) for the different respective flow rates. In these operating conditions, both filter elements are in communication one to each other and the first valve assembly is in the open position. Valve 40 is opened and valve 11 is closed.

At the end of the production step, when the total amount of PVPP is dosed and deposit on the filter. This operation is called “postrun” or “nachlauf”, and is the reverse operation than the previous one, called “vorlauf”. As it was explained before, the mixture beer/water is recovered to the pre and post run filtered liquid tank when the specific gravity of the diluted treated beer is higher than a predetermined target.

After that moment, the blending is not recovered and is put to the drain, which determines the end of the production phase and the start of the regeneration process. The possible residual quantity of PVPP can be pumped to the filter by using pumps (34) and/or (35) used for the pre-coat deposition. In the present invention the regeneration process will be realized within the filter, referring to in-situ process and will use the different chemical solutions available for the cleaning and disinfection operations of the installation, what the brewer called “Cleaning in Place” (CIP). The temperature of the filter is progressively increased by adding hot water at a temperature around 80° C., which is the appropriate temperature required for the caustic treatment. The concentration of caustic soda is generally around 2% and is necessary to remove the polyphenols fixed on the surface of the PVPP. This first “attack” occurs during a period between 30 and 60 minutes, depending on the quantity of soluble material and the concentration of the caustic solution. If unused PVPP particles are still present in the dosing/storage tank they can be pumped before recirculating with the caustic solution. The recirculation step used the by-pass loop, such as used during the pre-coat deposition, when valves (52), (53), (54), (25), (2) and (15) are opened and when the flow rate is controlled by a flow meter, which controls the alimentation of the pump (8). The filter-cake is afterwards successively washed with hot water at 80° C., cold water at room temperature (PW) and an acid solution, in order to neutralize the residue of caustic present in the stabilization-cake. Before starting a new stabilization process the cleaned stabilization-cake should be removed from the filter medium, by using DW and CO2 and should be pumped to the alternate dosing/storage tank (30), when valves (28) and (39) are opened. The PVPP is now ready to start a new stabilization process.

Although the preferred embodiments of the invention have been disclosed for illustrative purpose, those skilled in the art will appreciate that various modifications, additions or substitutions are possible, without departing from the scope and spirit of the invention as disclosed in the accompanying claims.

1. Filtration and/or stabilizing equipment comprising:
a first storage tank and a second storage tank,
a first filter element and a second filter element,
said first storage tank being connected to the first filter element and said second storage tank being connected to the second filter elemental,
a first nozzle interconnecting an outlet of said first filter element to an inlet of said second filter element, said first nozzle comprising a first valve assembly having an open position and a closed position,
said open position being a position allowing the outlet of said first filter element to be connected to the inlet of the second filter element while the closed position isolates the outlet of said first filter element from the inlet of the second filter element, said first valve assembly comprising a first valve and a second valve, said first valve assembly being in open position when said second valve is open and said first valve is closed and being in closed position when said second valve is closed and said first valve is open.

2. Filtration and/or stabilizing equipment according to claim 1, further comprising a second nozzle connecting an inlet of said first filter element to an outlet of a third storage tank, provided to contain unfiltered medium, said second nozzle being further connected to said first valve for connecting said third storage tank to said inlet of said second filter element when the first valve assembly is in closed position.

3. Filtration and/or stabilizing equipment, according to claim 1, wherein said first nozzle comprises a second valve assembly between said second filter element and said second storage tank, said second valve assembly having an open position and a closed position, said open position being a position where the second filter element is connected to the second storage tank and the closed position is a position where the second filter element is isolated from said second storage tank.

4. Filtration and/or stabilizing equipment according to claim 3, further comprising a fourth storage tank, having an outlet connected to said first nozzle by means of at least one third valve which is in closed position when the second valve assembly is in opened position and which is in open position when the second valve assembly is in closed position thereby allowing the connection between the fourth storage tank and the second filter element.

5. Filtration and/or stabilizing equipment according to claim 1, wherein the first, the second or the fourth storage tank is provided to contain a filter aid medium chosen in the group consisting of Kieselguhr medium, diatomaceous earth, perlite, single use PVPP (polyvinylpolypyrrolidone), regenerable PVPP, silicagels, bentonite (earth), synthetic materials, and their mixture.

6. Filtration and/or stabilizing equipment according to claim 5, wherein the synthetic material is chosen in the group consisting of polyamide, polyvinylchloride, fluorinated products, polypropylene, polystyrene, polyethylene, polybutene, polymethylpentene, ethylene copolymers, binary copolymers and terpolymers with acrylics, olefinic thermoplastic elastomers, and mixture, polypolymers and co-extrusion thereof, and mixture thereof.

7. Filtration and/or stabilizing equipment according to claim 5, wherein the synthetic material has an average diameter ranging between 25 and 50 μm and preferably between 30 and 40 μm.

8. Filtration and/or stabilizing equipment according to claim 1 wherein the first filter element is an horizontal leaf filter, a candle filter or a vertical leaf filter and wherein the second filter element is a candle filter.

9. Filtration and/or stabilizing equipment according to claim 1 wherein said medium is a fruit or grain based beverage, particularly a cereal based beverage, more particularly a malt based beverage and most particularly a fermented beverage, preferably beer.

10. Filtration and/or stabilizing equipment, according to claim 1, wherein the medium presents a pH between 2 and 6 and preferably between 3 and 5.

11. Filtration and/or stabilizing equipment according to claim 1, wherein said first storage tank and said second storage tank both comprise a mixture of Kieselguhr of diatomaceous earth or perlite with single use PVPP.

12. Filtration and/or stabilizing equipment according to claim 1, wherein said first storage tank and said second storage tank comprising Kieselguhr, diatomaceous earth or perlite, said fourth storage tank comprises regenerable PVPP.

13. Filtration and/or stabilizing equipment according to claim 1, wherein said fourth storage tank comprises a mixture of regenerable PVPP with synthetic polymers.

14. Filtration and/or stabilizing method of an unfiltered medium comprising:
a first addition of a first filter aid from a first storage tank to said unfiltered medium coming from a third storage tank,
a first filtration of said unfiltered medium comprising said first filter aid to obtain a first filtrate,
a second addition of a second filter aid from a second or a fourth storage tank (30) to a second unfiltered medium,
a second filtration of said unfiltered medium comprising said second filter aid to obtain a second filtrate,
a switch of a first valve assembly from a closed position to an open position, said closed position being a position where the first filtration is followed by the second filtration, said first filtrate being said second unfiltered medium subjected to the second filtration and the open position being a position where the first filtration is performed independently and simultaneously with respect to the second, said unfiltered medium being the same as the second unfiltered medium, said first filter aid and said second filter aid being the same or not.

15. Filtration and/or stabilizing method of an unfiltered medium according to claim 14 further comprising a switch of a second valve assembly from a closed position to an open position to add the second filter aid from said second storage tank or from an open position to a closed position together with a switch of a third valve from a closed position to an open position to add the second filter aid from said fourth storage tank.

16. The method according to claim 14, wherein the first, the second or the fourth storage tank are provided to contain a filter aid medium chosen in the group consisting of Kieselguhr medium, diatomaceous earth, perlite, single use PVPP (polyvinylpolypyrrolidone), regenerable PVPP, silicagels, bentonite (earth), synthetic materials, and their mixture.

17. The method according to claim 16, wherein the synthetic material is chosen in the group consisting of polyamide, polyvinylchloride, fluorinated products, polypropylene, polystyrene, polyethylene, polybutene, polymethylpentene, ethylene copolymers, binary copolymers and terpolymers with acrylics, olefinic thermoplastic elastomers, and mixture, polypolymers and co-extrusion thereof, and mixture thereof.

18. The method according to claim 16, wherein the synthetic material has an average diameter ranging between 25 and 50 μm and preferably between 30 and 40 μm.

19. The method according to claim 14, wherein said medium is a fruit or grain based beverage, particularly a cereal based beverage, more particularly a malt based beverage and most particularly a fermented beverage, preferably beer.

20. Filtration and/or stabilizing method of an unfiltered medium according to claim 15, further comprising a shutting off of a first filtration unit where first filtration is performed, said second filtration being performed with said second filter aid coming from the fourth storage tank which comprises a mixture of regenerable PVPP and synthetic polymers.
